(19) United States
(12) Patent Application Publication
(10) Pub. No.: US 2024/0370760 A1
(43) Pub. Date: Nov. 7, 2024

(54) METHOD AND SYSTEM OF MANAGING ARTIFICIAL INTELLIGENCE/MACHINE LEARNING (AI/ML) MODEL

(71) Applicant: RAKUTEN MOBILE, INC., Tokyo (JP)

(72) Inventors: Awn MUHAMMAD, Tokyo (JP); Koichiro KITAGAWA, Tokyo (JP); Taewoo LEE, Tokyo (JP)

(73) Assignee: RAKUTEN MOBILE, INC., Tokyo (JP)

(21) Appl. No.: 18/031,046

(22) PCT Filed: Mar. 10, 2023
(86) PCT No.: PCT/US2023/014938

§ 371 Date: Apr. 10, 2023

Related U.S. Application Data
(63) Continuation of application No. 17/795,400, filed on Jul. 26, 2022.
(60) Provisional application No. 63/335,916, filed on Apr. 28, 2022.

(51) Int. Cl. G06N 20/00; G06N 5/04

(52) U.S. Cl. CPC G06N 20/00; G06N 5/04

(57) ABSTRACT

Provided are methods and systems for managing artificial intelligence/machine learning (AI/ML) in a telecommunications system. According to embodiments, a method of implementing AI/ML for air interface optimization in the telecommunications system is provided. The method may include: determining, by a first node, a collaboration level for AI/ML collaboration between a network and a user equipment (UE), from among a plurality of predetermined collaboration levels; performing, by a second node, air interface optimization with respect to the UE using at least one AI/ML model, based on the determined collaboration level, wherein the plurality of predetermined collaboration levels comprises: a first level corresponding to AI/ML collaboration between the network and the UE, a second level corresponding to a signaling-based AI/ML collaboration between the network and the UE without model transfer, and a third level corresponding to a signaling-based AI/ML collaboration between the network and the UE with model transfer.

### CROSS REFERENCE TO RELATED APPLICATIONS

This application claims the benefit of Provisional Patent Application No. 63/335,916, filed with the United States Patent and Trademark Office (USPTO) on Apr. 28, 2022 and entitled “AI/ML MODEL LIFE CYCLE MANAGEMENT”, and claims the benefit of U.S. patent application Ser. No. 17/795,400, filed with the USPTO on Jul. 26, 2022 as a National Stage of International Application No. PCT/US2022/026646 filed Apr. 28, 2022, the disclosures of which are incorporated herein by reference in their entireties.

### TECHNICAL FIELD

Methods and systems consistent with example embodiments of the present disclosure relate to managing Artificial Intelligence (AI)/Machine Learning (ML) models, and more specifically, relate to managing collaboration between nodes in a telecommunications system, and AI/ML model life cycle management therefor.

### BACKGROUND

Recently, there has been an increasing interest in implementing AI/ML in telecommunications systems. Nevertheless, a framework and approach for managing and/or for utilizing AI/ML models in telecommunications systems remain unclear and unspecified to date. Particularly, the collaboration between nodes (e.g., user equipment, base station, network function, etc.) in telecommunications systems in managing and/or utilizing AI/ML models, as well as the approach for providing life cycle management for the AI/ML models, remain unclear and undefined.

In view of the above, there is a need to define the framework and procedures associated with the collaboration or corporation among nodes in telecommunications systems. For instance, there is a need to define the framework and procedures for model information exchange, for model training, for providing model performance feedback, for initiating or transferring model between nodes, and the like.

Further, for realizing collaboration or cooperation between the nodes, there is a need to define the procedures and signaling protocols or flows according to AI/ML capabilities of the nodes. Similarly, there is a need to define or classify AI/ML capabilities, as well as to categorize AI/ML model trainings.

### SUMMARY

According to embodiments, systems and methods are provided for facilitating collaboration between nodes in a telecommunications system. Specifically, according to embodiments, systems and methods are provided for facilitating collaboration between nodes in the telecommunications system for implementing AI/ML for optimization of air interfaces, and AI/ML model life cycle management therefor. According to embodiments, systems and methods are provided for AI/ML model/inference usage in a cooperative manner, and more particularly, AI/ML model/inference usage for optimizing an air interface in a telecommunications system.

According to embodiments, a method of implementing artificial intelligence/machine learning (AI/ML) for air interface optimization in a mobile telecommunications system may be provided. The method may include: determining, by a first node, a collaboration level for AI/ML collaboration between a network and a user equipment (UE), from among a plurality of predetermined collaboration levels; performing, by a second node, air interface optimization with respect to the UE using at least one AI/ML model, based on the determined collaboration level, wherein the plurality of predetermined collaboration levels may include: a first level corresponding to AI/ML collaboration between the network and the UE, a second level corresponding to a signaling-based AI/ML collaboration between the network and the UE without model transfer, and a third level corresponding to a signaling-based AI/ML collaboration between the network and the UE with model transfer.

According to embodiments, in accordance with the second level, AI/ML model training may occur at both the network and the UE.

According to embodiments, in accordance with the second level, the network may provide AI/ML model and/or inference tuning parameters to the UE.

According to embodiments, the second level may include a plurality of split levels. A first split level, of the plurality of split levels, may correspond to a signaling-based AI/ML collaboration for one-sided models without joint inference performed jointly across the UE and the network. A second split level, of the plurality of split levels, may correspond to a signaling-based AI/ML collaboration for two-sided models with joint inference performed jointly across the UE and the network.

Alternatively or additionally, the second level may correspond to a signaling-based AI/ML collaboration for one-sided models without joint inference performed jointly across the UE and the network, and the third level may correspond to a signaling-based AI/ML collaboration for two-sided models with joint inference performed jointly across the UE and the network.

According to embodiments, the model transfer may include at least one of a transfer of parameters of an AI/ML model structure or a transfer of a new AI/ML model with parameters, the new AI/ML model may be a full model or a partial model.

According to embodiments, the determining the collaboration level may include: transmitting, by the first node to the UE, an AI/ML capability request inquiring about AI/ML capabilities of the UE; receiving, by the first node from the UE, an AI/ML capability report in response to the AI/ML capability request, the AI/ML capability report indicating the AI/ML capabilities of the UE; and determining the collaboration level, from among the plurality of predetermined collaboration levels, based on the received AI/ML capability report.

According to embodiments, the method may further include: transmitting, by the first node to the UE, a request for information on at least one of AI/ML models stored in the UE or AI/ML models to be used by the UE.

According to embodiments, the air interface optimization may include at least one of Channel State Information (CSI) feedback enhancement, beam management, and positioning accuracy enhancement.

According to embodiments, in accordance with the second level, full scale AI/ML model training may occur at the UE; and in accordance with the third level, light weight AI/ML model training may occur at the UE.

According to embodiments, a system of implementing artificial intelligence/machine learning (AI/ML) for air interface optimization in a mobile telecommunications system may be provided. The system may include: a first node including a memory storing instructions and at least one processor configured to execute the instructions to: determine a collaboration level for AI/ML collaboration between a network and a user equipment (UE), from among a plurality of predetermined collaboration levels; and a second node including a memory storing instructions and at least one processor configured to execute the instructions to: perform air interface optimization with respect to the UE using at least one AI/ML model, based on the determined collaboration level; wherein the plurality of predetermined collaboration levels may include: a first level corresponding to AI/ML collaboration between the network and the UE, a second level corresponding to a signaling-based AI/ML collaboration between the network and the UE without model transfer, and a third level corresponding to a signaling-based AI/ML collaboration between the network and the UE with model transfer.

According to embodiments, in accordance with the second level, AI/ML model training may occur at both the network and the UE.

According to embodiments, in accordance with the second level, the network may provide AI/ML model and/or inference tuning parameters to the UE.

According to embodiments, the second level may include a plurality of split levels. A first split level, of the plurality of split levels, may correspond to a signaling-based AI/ML collaboration for one-sided models without joint inference performed jointly across the UE and the network. A second split level, of the plurality of split levels, may correspond to a signaling-based AI/ML collaboration for two-sided models with joint inference performed jointly across the UE and the network.

Alternatively or additionally, the second level may correspond to a signaling-based AI/ML collaboration for one-sided models without joint inference performed jointly across the UE and the network, and the third level may correspond to a signaling-based AI/ML collaboration for two-sided models with joint inference performed jointly across the UE and the network.

According to embodiments, the model transfer may include at least one of a transfer of parameters of an AI/ML model structure or a transfer of a new AI/ML model with parameters, the new AI/ML model may be a full model or a partial model.

According to embodiments, the at least one processor of the first node may be configured to execute the instructions to determine the collaboration level by: transmitting, by the first node to the UE, an AI/ML capability request inquiring about AI/ML capabilities of the UE; receiving, by the first node from the UE, an AI/ML capability report in response to the AI/ML capability request, the AI/ML capability report may indicate the AI/ML capabilities of the UE; and determining the collaboration level, from among the plurality of predetermined collaboration levels, based on the received AI/ML capability report.

According to embodiments, the at least one processor of the first node may be further configured to execute the instructions to transmit, to the UE, a request for information on at least one of AI/ML models stored in the UE or AI/ML models to be used by the UE.

According to embodiments, the air interface optimization may include at least one of Channel State Information (CSI) feedback enhancement, beam management, and positioning accuracy enhancement.

According to embodiments, in accordance with the second level, full scale AI/ML model training may occur at the UE, and in accordance with the third level, light weight AI/ML model training may occur at the UE.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates a functional system architecture or framework for AI/ML application in a radio access network (RAN), according to one or more embodiments;

FIG. 2 illustrates a flow diagram of an example method of implementing AI/ML for air interface optimization in a mobile telecommunications system, according to one or more embodiments;

FIG. 3 illustrates a flow diagram of an example method of determining a collaboration level, according to one or more embodiments;

FIG. 4 illustrates examples of procedure involved in life cycle management of one or more AI/ML models, according to one or more embodiments;

FIG. 5 illustrates a signaling flow between a first node and a second node for a collaborative AI/ML model usage, according to one or more embodiments; and

FIG. 6 illustrates a breakdown of categories of AI/ML model trainings, according to one or more embodiments.

Additional aspects will be set forth in part in the description that follows and, in part, will be apparent from the description, or may be realized by practice of the presented embodiments of the disclosure DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are disclosed in the specification, these combinations are not intended to limit the disclosure of possible implementations. In fact, many of these features may be combined in ways not specifically disclosed in the specification.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Further, the terms “AI/ML model”, and the like, as used herein, may refer to a data driven algorithm that applies artificial intelligence (AI)/machine learning (ML) techniques to generate one or more outputs based on one or more inputs.

### General System Architecture

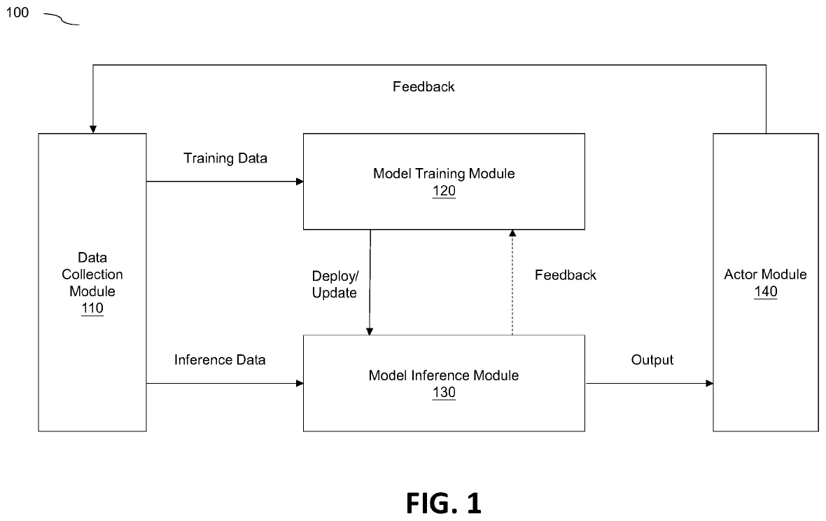

FIG. 1 illustrates a functional system architecture or framework for AI/ML application in a radio access network (RAN), according to one or more embodiments. Referring to FIG. 1, system 100 may include a data collection module 110, a model training module 120, a model inference module 130, and an actor module 140.

According to embodiments, the data collection module 110 may be a function (or an element/entity configured to perform the function) which collects data and provides data to the model training module 120 and to the model inference module 130.

For instance, the data collection module 110 may collect data from one or more nodes and/or one or more network functions in the system, such as (but not limited to): user equipment (UE), base station (e.g., gNB), location management function (LMF), access and mobility management function (AMF), and operation and management (OAM) function or entity. The collected data may include measurement (e.g., status measurement, performance measurement, etc.) from the one or more nodes and/or one or more network functions, feedback from the actor module 140, output from an AI/ML model, and any other suitable data.

Further, the data collection module 110 may provide the collected data to the model training module 120, such that said data may be utilized for training the AI/ML model (in this regard, data provided to the model training module 120 may be referred to as “training data” herein). According to embodiments, the training data may include offline field data (e.g., data collected from field and used for offline training of the AI/ML model) and online field data (e.g., data collected from field and used for online training of the AI/ML model).

In addition, the data collection module 110 may provide the collected data to the model inference module 130, such that said data may be utilized for inference operation (in this regard, data provided to the model inference module 130 may be referred to as “inference data” herein)

According to embodiments, the data collection module 110 may be communicatively coupled to one or more additional modules which are configured to perform one or more data preparation operations, such as (but not limited to): data pre-processing, data cleaning, data formatting, and data transformation, and may be configured to collect data from said one or more additional modules. According to other embodiments, data collection module 110 may be configured to perform said one or more data preparation operations.

Further, according to embodiments, the model training module 120 may be a function (or an element/entity configured to perform the function) that performs training operation of one or more AI/ML models (may refer to as “AI/ML model training” herein). The AI/ML model training may refer to a process to train the one or more AI/ML models by learning the input/output relationship in a data driven manner and obtain the trained AI/ML model therefrom. Further, the AI/ML model training may be performed online and/or offline, and may be performed at the UE and/or at the network.

According to embodiments, the AI/ML model training may include AI/ML model validation and/or Al/ML model testing. Al/ML model validation may be a process to evaluate the quality of the AI/ML model using a dataset different from the one used for model training, while the AI/ML model testing may be a process to evaluate the performance of a final AI/MIL model using a dataset different from the one used for model training and validation.

For instance, the model training module 120 may be configured to obtain or request for data (e.g., training data, etc.) or information (from the data collection module 110, etc.), to receive the requested data or information, and to execute one or more AI/ML algorithms to perform (based on the received data or information) one or more of model training, model validation, and model testing. Further, the model training module 120 may be configured to provide or deploy one or more trained model, validated model, and/or tested model to the model inference module 130.

According to embodiments, the model training module 120 may be configured to generate model performance metrics via model testing operation. Further, the model training module 120 may be configured to perform the one or more data preparation operations based on the training data provided by the data collection module 110. Furthermore, the model training module 120 may be configured to receive (from other module or entity) one or more trained models, one or more validated models, and/or one or more tested models, and to update, upgrade, and/or roll back the one or more trained models, the one or more validated models, and/or the one or more tested models.

On the other hand, according to embodiments, the model inference module 130 may be a function (or an element/entity configured to perform the function) that performs one or more inference operations associated with the AI/ML model (may referred to as “AI/ML model inference” herein). AI/ML model inference may be a process of using a trained AI/ML model to produce one or more outputs based on one or more inputs. For instance, AI/ML model inference may include one or more operations of utilizing the trained AI/ML model and the inference data to predict or decide one more outputs of the trained AI/ML model.

By way of example, the model inference module 130 may be configured to obtain or request data (e.g., inference data, AI/ML model(s) etc.) or information (from the data collection module 110, from the model training module 120, etc.), to receive the requested data or information, and to perform the one or more AI/ML model inferences based on the received data or information. According to embodiments, the model inference module 130 may be configured to perform said one or more inference operations on one or more trained models, one or more validated models, and/or one or more tested models (e.g., provided by the model training module 120, etc.), based on the inference data provided by the data collection module 110.

Further, the model inference module 130 may be configured to provide one or more inference outputs to the actor module 140. According to embodiments, the model inference module 130 may be configured to monitor the performance of the AI/ML model(s), and to provide the performance of the AI/ML model (may be referred to as “model performance feedback” herein) to the model training module 120, so that the model training module 120 may utilize the model performance feedback in performing one or more of the model training, model validation, and model testing.

According to embodiments, the model inference module 130 may be configured to perform the one or more data preparation operations based on the inference data provided by the data collection module 110. Further, the model inference module 130 may be configured to signal the inference output(s) of the model to node(s) that has requested for the inference output, and/or to node(s) that takes action(s) based on the inference output(s).

Furthermore, according to embodiments, the actor module 140 may be a function (or an element/entity configured to perform the function) that performs one or more actions based on the inference output provided by the model inference module 130. For instance, the actor module 140 may be configured to trigger or perform one or more actions directed to other entities (e.g., other modules, other nodes, other functions, etc.) and/or to itself. Further, the actor module 140 may be configured to provide feedback data or information to the data collection module 110. The feedback data or information may include any suitable data which may be utilized in deriving training data, inference data, and/or in monitoring the performance of the AI/ML model and its impact to the network.

It is contemplated that the example embodiments described above are merely possible embodiments, and the scope of the present disclosure should not be limited thereto. Further, it is contemplated that one or more of modules 110-140 in system 100 may be implemented or be deployed in software form, in hardware form, or a combination thereof. According to embodiments, one or more of the modules 110-140 may be implemented or be deployed in the form of computer-readable and/or computer-executable instructions which, when being read or executed by at least one processor, cause the at least one processor to perform one or more operations associated with said modules.

To this end, system 100 provides a framework for managing intelligence and data of one or more AI/ML models in RAN. Accordingly, system 100 (and the associated architecture) may be utilized for various purposes in a telecommunications systems. For instance, one or more example embodiments may apply the system 100 for AI/ML optimization of air interfaces in the telecommunications system. In one or more embodiments, the air interface is a 5G New Radio (NR) air interface, and the air interface optimization may include channel state information (CSI) feedback enhancement, beam management, positioning accuracy enhancement, and optimization of any other suitable air interface related operations and features. Furthermore, it is also contemplated that system 100 may be utilized in any other possible use cases (e.g., network energy saving, load balancing, mobility optimization, etc.).

### Categorization of Cooperation Level of AI/ML Usage

According to example embodiments, there is provided (e.g., a telecommunications system applies or standardizes) a plurality of predetermined levels or categories of AI/ML collaboration or cooperation between network nodes and/or network functions in the telecommunications system, such as, the user equipment (UE), the base station (e.g., gNB), the location management function (LMF), the access and mobility management function (AMF), and operation and management (OAM) function.

Table 1 below illustrates an example of a plurality of predetermined levels of AI/ML collaboration or cooperation with respect to AI/ML standardization and gNB/UE capabilities, according to an embodiment:

| Cooperation | | | |
|---|---|---|---|
| Level Category | Collaboration | gNB role | UE role |
| #0 | AI/ML is fully | Implementation specific | Implementation specific |
| Implementation | implementation based | Built in AI/ML Model(s) | Built in AI/ML Model(s) |
| #1 | AI/ML usage without | Update AI/ML | Update AI/ML Model/ |
| Information | Model transfer. | Model/inference & | Inference & related |
| exchange | Information exchange | related parameters. | parameters. |
| | between gNB and UE | Provide AI/ML | Provide parameters for |
| | for AI/ML usage. | model/inference tuning | tuning of AI/ML at gNB. |
| | Model Training at gNB | parameters to UE. | Model training at UE |
| | and/or UE. | Model training at gNB. | |
| #2 | Model exchange | Transfer AI/ML model | Transfer AI/ML model to |
| Model | between gNB and UE. | to UE. | gNB. |
| Exchange | Model update from | Update or download new | Download model from |
| | external repository. | models from repository. | gNB. |
| | | | Update or download new |
| | | | models from repository. |

It is contemplated that, although Table 1 illustrates an example collaboration among UE and gNB and the associated role in the example collaboration, similar disclosures may be applicable to collaboration among the UE and any suitable network (e.g., gNB, network functions such as LMF, AMF, OAM, etc.), and the like, without departing from the scope of the present disclosure.

As illustrated in Table 1, the plurality of predetermined levels of AI/ML cooperation (or collaboration) may include three levels or categories, namely, level #0, level #1, and level #2 (though it is understood that one or more other embodiments are not limited thereto, and can include two levels or categories or more than three levels or categories).

At the first level #0, implementation-based AI/ML algorithms are used. Namely, at the first level #0, the UE and/or the network (e.g., gNB, LMF, AMF, OAM, etc.) may utilize one or more specific built-in AI/ML models, without information exchange with one another. The specific built-in AI/ML models may be provided by any suitable personnel, such as: a vendor of the UE, a network operator, and the like. According to embodiments, one or more of the AI/ML models being utilized at one side is transparent to the other side. Further, one or more of the AI/ML models may be a base model similarly built-in at multiple sides (e.g., the UE and the network may have similar base model(s), etc.).

At the second level #1, information exchange may occur. Namely, at the second level #1, the UE and/or the network (e.g., gNB, LMF, AMF, OAM, etc.) utilize one or more AI/ML models with exchanged information, without transferring the one or more AI/ML models to each other. For instance, in the case in which the collaboration is between a UE and a gNB, the UE and the gNB may exchange information for AI/ML usage, while the specific operations associated with the AI/ML model (e.g., training, validation, testing, inference, etc.) may be performed separately at the UE and/or the gNB.

According to embodiments, the information being exchanged among the UE and the network may include AI/ML model and/or inference tuning parameters. In this regard, the UE and/or the network may be configured to train one or more AI/ML model, to update one or more AI/ML model and/or the related parameters (e.g., based on the exchanged information, etc.), and to provide the AI/ML model and/or inference tuning parameters to each other. For instance, in uplink use cases, the UE may provide parameters or information to a gNB such that the gNB may tune its AI/ML model based on the provided parameters or information. As another example, the UE may have specific built-in parameters (e.g., provided by the UE vendor, etc.) which the UE would like to utilize, and thus, the UE may provide said parameters to the gNB such that the gNB may utilize said parameters.

Furthermore, according to embodiments, the second level #1 may include a plurality of split levels, such as: a first split level #1A and a second split level #1B. The first split level #1A may correspond to a signaling-based Al/ML collaboration for one-sided model(s) with/without joint operation, and the second split level #1B may correspond to a signaling-based AI/ML collaboration for two-sided model(s) with/without joint operation.

The terms “one-sided model” may refer to an AI/ML model which is utilized (e.g., trained, validated, tested, inferenced, etc.) at one side and is independent from another side. For instance, a one-sided model may be a UE-side AI/ML model (e.g., AI/ML model whose inference is to be performed at the UE), a network-side model (e.g., AI/ML model whose inference is to be performed at the network), and the like.

The terms “two-sided model” may refer to an AI/ML model which is utilized (e.g., trained, validated, tested, inferenced, etc.) at both sides. For example, a two-sided model may be an AI/ML model which is firstly utilized at the UE, and then utilized at the gNB, or vice-versa.

The terms “joint operation” may refer to one or more operations (e.g., training, validation, testing, inference operation, etc.) performed jointly across the nodes and/or the networks. For instance, a joint operation may include a joint inference, in which one or more inference operations (e.g., prediction, decision, etc.) are performed jointly across the nodes and/or the networks (e.g., a joint inference may be performed across a UE and a gNB, wherein a first part of inference is performed by the 4 UE and a second part of inference is performed by the gNB, etc.).

In view of the above, the first split level #1A may correspond to a signaling-based AI/ML collaboration for one-sided model(s) with/without joint inference performed jointly across a UE and a network (e.g., gNB, network functions such as LMF, AMF, OAM, etc.), and the second split level #1B may correspond to a signaling-based AI/ML collaboration for two-sided model(s) with/without joint inference performed jointly across the UE and the network.

To this end, the second level #1 (and the split levels associated therewith) defines model assistance information exchange and mode/inference parameter exchange or update among the UE and the network. Further, the second level #1 (and the split levels associated therewith) defines framework to provide feedback or information on model performance among the UE and the network. Furthermore, the second level #1 (and the split levels associated therewith) defines framework for model training (e.g., based on UE, etc.).

At the third level #2, model exchange or model transfer may occur. Namely, at the third level #2, the UE and/or the network (e.g., gNB, LMF, AMF, OAM, etc.) may exchange one or more AI/ML models. For instance, the network may transfer one or more AI/ML models to the UE, the UE may transfer one or more AI/ML models to the network, the UE may download one or more AI/ML models from the network, and the like. The model transfer may include at least one of a transfer of parameters of an AI/ML model structure, a transfer of a new AI/ML model (e.g., a new full AI/ML model, a new partial AI/ML model, etc.) with parameters, and the like.

According to embodiments, at the third level #2, the UE and/or the network may obtain updates of one or more AI/ML models from one or more external repositories. For instance, the UE and/or the network may download an updated model or a new model from the external repository(s), and the like. Further, at the third level #2, a light weight AI/ML model training may occur at the UE and/or at the network.

To this end, the third level #2 defines a framework to initiate, transfer, and validate one or more AI/ML models between a UE and a network (e.g., gNB, LMF, AMF, OAM, etc.).

According to embodiments, the information exchange may be performed based on ID of the associated AI/ML model(s). For instance, the network may provide the AI/ML model and/or inference tuning parameters to the UE based on the model ID, and the like. Further, according to embodiments, at the second level #1, a full scale AI/ML model training may occur at the UE and/or at the network.

Further, according to an embodiment, one or more AI/ML models may be applied for air interface optimization based on implementation or selection of a particular level (or category) of collaboration from among a plurality of predetermined levels (or categories). For instance, the air interface optimization may include channel state information (CSI) feedback enhancement, beam management, positioning accuracy enhancement, and optimization of any other suitable air interface related operations and features. Furthermore, it is contemplated that the one or more AI/ML models may also be utilized in any other possible use cases (e.g., network energy saving, load balancing, mobility optimization, etc.) based on implementation or selection of a particular level (or category) of collaboration from among a plurality of predetermined levels (or categories).

### Classification of AI/ML Capability

AI/ML capability may refer to the ability of capability of a UE and/or a network (e.g., gNB, LMF, AMF, OAM, etc.) to perform one or more AI/ML related tasks.

According to embodiments, the AI/ML capability of the UE may be divided into the following classes: Class 0, Class 1, Class 2, and Class 3.

UE falls under Class 0 may have no AI/ML capability. UE falls under Class 1 may only support information exchange. UE falls under Class 2 may support information exchange and model transfer. UE falls under Class 3 may support information exchange, model transfer, and model training.

In view of the above, a Class 0 UE may be capable to perform one or more AI/ML tasks based on the above described first level #0 collaboration, a Class 1 UE may be capable to perform one or more AI/ML tasks based on the above described second level #1 collaboration, and a Class 2 UE and a Class 3 UE may be capable to perform one or more AI/ML tasks based on the above described third level #2 collaboration.

It can be understood that, although the above descriptions are set forth with reference to classification of AI/ML capabilities of UE, similar classification may be applicable to any nodes or network (e.g., gNB, LMF, AMF, OAM, etc.), without departing from the scope of the present disclosure.

To this end, example embodiments of the present disclosure define classifications of AI/ML capabilities of nodes.

### Example Use Case: AI/ML Implementation for Air Interface Optimization

As described above, according to an embodiment, AI/ML may be implemented for air interface optimization in a mobile telecommunications system.

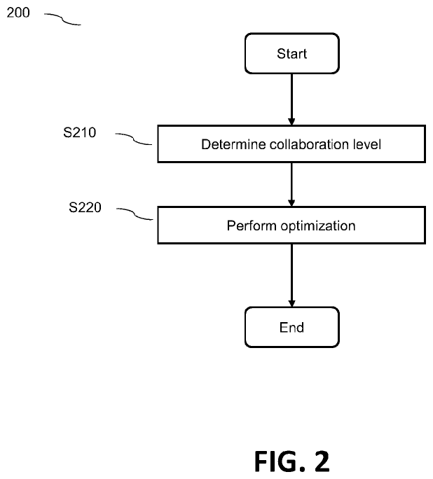

FIG. 2 illustrates a flow diagram of an example method 200 of implementing AI/ML for air interface optimization in a mobile telecommunications system, according to one or more embodiments.

Referring to FIG. 2, at operation S210, a collaboration level is determined. Specifically, a first node may be configured to determine a collaboration level for AI/ML collaboration between a network and a user equipment (UE) from among a plurality of predetermined collaboration levels.

According to embodiments, the first node may be the UE, the network (e.g., gNB, LMF, AMF, OAM, etc.), or any other suitable node or element in the mobile telecommunications system.

Further, the plurality of predetermined collaboration levels may include: a first level corresponding to AI/ML collaboration between the network and the UE, a second level corresponding to a first signaling-based AI/ML collaboration between the network and the UE, and a third level corresponding to a second signaling-based AI/ML collaboration between the network and the UE.

According to embodiments, the first level, the second level, and the third level may correspond to the above described first level #0, the above described second level #1, and the above third level #2, respectively. For instance, the second level may correspond to a signaling-based AI/ML collaboration between the network and the UE without model transfer, and the third level may correspond to a signaling-based AI/ML collaboration between the network and the UE with model transfer.

In this regard, the second level may include a plurality of split levels, such as a first split level (e.g., above described first split level #1A) corresponds to a signaling-based AI/ML collaboration for one-sided model(s) with/without joint inference performed jointly across the UE and the network, and a second split level (e.g., above described second split level #1B) corresponds to a signaling-based AI/ML collaboration for two-sided model(s) with/without joint inference performed jointly across the UE and the network. Further, the model transfer may include at least one of a transfer of parameters of an AI/ML model structure or a transfer of a new AI/ML model with parameters, wherein the new AI/ML model may be a full model or a partial model.

Alternatively, the second level and the third level may correspond to the above described first split level and the above described second split level, respectively. For instance, the second level may correspond to a signaling-based AI/ML collaboration for one-sided model(s) without joint inference performed jointly across the UE and the network, and the third level may correspond to a signaling-based AI/ML collaboration for two sided model(s) with/without joint inference performed jointly across the UE and the network.

According to embodiments, in accordance with the second level, AI/ML model training may occur at both the network and the UE. Additionally or alternatively, in accordance with the second level, the network may provide AI/ML model and/or inference tuning parameters to the UE.

According to embodiments, in accordance with the second level, full scale AI/ML training may occur at the UE, and in accordance with the third level, light weight AI/ML model training may occur at the UE.

Referring still to FIG. 2, at operation S220, one or more air interface optimizations are performed. Specifically, a second node may be configured to perform one or more air interface optimizations with respect to the UE using at least one AI/ML model, based on the determined collaboration level (e.g., collaboration level determined at operation S210). The second node may be the UE or the network (e.g., gNB, LMF, AMF, OAM, etc.), or any other suitable node or element in the mobile telecommunications system. The one or more air interface optimizations may include channel state information (CSI) feedback enhancement, beam management, positioning accuracy enhancement, and optimization of any other suitable air interface related operations and features.

It is contemplated that method 200 may include one or more additional or alternative operations, without departing from the scope of the present disclosure.

For instance, according to embodiments, method 200 may include an operation in which the first node may be configured to transmit, to the UE, a request for information on at least one of AI/ML model(s) stored in the UE or AI/ML model(s) to be used by the UE, and to receive said information from the UE. Alternatively or additionally, according to embodiments, method 200 may include an operation in which the first node may be configured to transmit, to an external repository, a request for information on at least one of AI/ML model(s) stored in the external repository or AI/ML model(s) to be used by the UE, and to receive said information from the external repository.

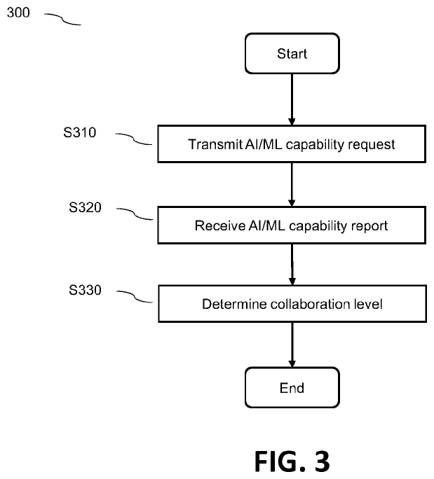

Similarly, one or more of the operations of method 200 may include one or more additional operations, without departing from the scope of the present disclosure. For instance, FIG. 3 illustrates a flow diagram of an example method 300 of determining the collaboration level (i.e., operation S210 in method 200), according to one or more embodiments.

Referring to FIG. 3, at operation 5310, one or more AI/ML capability requests are transmitted. Specifically, the first node may be configured to transmit, to the UE, one or more AI/ML capability requests inquiring about AI/ML capabilities of the UE. According to embodiments, the one or more AI/ML capability requests may include a request for information defining a classification of the AI/ML capabilities (e.g., above described Class 0-Class 3) of the UE.

At operation S320, one or more AI/ML capability reports are received. Specifically, the first node may be configured to receive, from the UE, one or more AI/ML capability reports in response to the AI/ML capability request(s), wherein the one or more AI/ML capability reports may indicate the AI/ML capabilities of the UE. According to embodiments, the one or more AI/ML capability reports may include information defining the classification of the AI/ML capabilities of the UE.

At operation S330, the collaboration level is determined. Specifically, the first node may be configured to determine the collaboration level, from among the plurality of predetermined collaboration levels, based on the received AI/ML capability report(s). According to embodiments, the first node may be configured to determine the collaboration level by determining the classification of the AI/ML capabilities of the UE.

### AI/ML Model Life Cycle Management

According to embodiments, the nodes (e.g., UE, network such as gNB, LMF, AMF, OAM, etc.) may collaborate with each other to perform life cycle management of one or more AI/ML models.

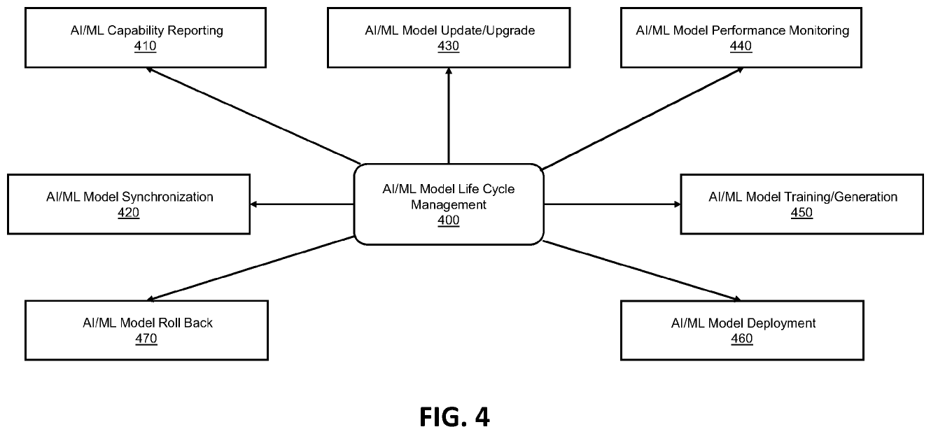

FIG. 4 illustrates examples of procedure involved in life cycle management of one or more AI/ML models, according to one or more embodiments.

Referring to FIG. 4, AI/ML model life cycle management 400 may include (but not limited to) the following procedures: AI/ML capability reporting procedure 410, AI/ML model synchronization procedure 420, AI/ML model update/upgrade procedure 430, AI/ML model performance monitoring procedure 440, AI/ML model training/generation procedure 450, AI/ML model deployment procedure 460, and AI/ML model roll back procedure 470.

It can be understood that said procedures 410-470 may occur in any order, without departing from the scope of the present disclosure. Further, it is contemplated that one or more of said procedures 410-470 may be combined with each other to form another procedure (e.g., AI/ML capability reporting and AI/ML model synchronization may be combined to form a procedure of AI/ML capability discovery, etc.), and/or may be included in one another (e.g., AI/ML model training/generation may be included in AI/ML model update, etc.)

Further, according to embodiments, at least one or all of the said procedures 410-470 may be applicable if one or more of “Information exchange,” “Model exchange,” and “Model training” are supported by the UE or the network.

According to embodiments, the AI/ML capability reporting procedure 410 may include one or more operations for reporting AI/ML capability of the UE and/or AI/ML capability of the network. For instance, a network (e.g., gNB) may inquire about the AI/ML capability of the UE by sending one or more AI/ML capability requests to the UE and by obtaining one or more AI/ML capability reports or responses from the UE, as described above.

According to embodiments, the AI/ML model synchronization procedure 420 may include one or more operations for discovering one or more repositories storing one or more AI/ML models and the information associated therewith, for obtaining one of more AI/ML models or the associated information from the discovered repository(s), and to update the current AI/ML model(s) (being stored or utilized by the UE and/or network such as gNB, etc.) with the obtained AI/ML model(s) or the information. For instance, the network (e.g., gNB) may, based on one or more requirements (e.g., AI/ML capability, optimization requirement, etc.), request for information of all stored AF/ML models or information of a specific Al/ML model(s).

According to embodiments, the AI/ML model update/upgrade procedure 430 may include one or more of the following operations: model update triggers, new model update (e.g., through model downloading or model exchange, etc.), model training/generation, update/upgrade of existing model (e.g., through information exchange, etc.), AI/ML inference update/transfer, model/inference selection procedure, model or inference validation, and retraining or fine tuning one or more AI/ML models.

According to embodiments, the AI/ML model performance monitoring procedure 440 may include one or more operations for monitoring performance of one or more AI/ML models. For instance, procedure 440 may include operation(s) for monitoring inference performance of one or more AI/ML models (e.g., through receiving feedback, etc.), after the one or more AI/ML models are deployed, trained/generated, and/or updated/upgraded.

According to embodiments, the AI/ML model training/generation procedure 450 may include one or more operations for training or generating one or more AI/ML models. The one or more operations may be any suitable operation(s) for learning the input/output relationship in a data driven manner and generate/obtain a trained AL/ML model therefrom. For instance, the one or more operations may include online training, offline training, or a combination thereof. Further, the one or more operations may occur at the UE, at the network (e.g., gNB, etc.), or a combination thereof. Furthermore, the one or more operations may include any suitable type of learning operations, such as (but not limited to): federated learning/training (in which one or more AI/ML models are trained across multiple nodes like UEs, gNBs, and the like, each performing local model training using local data samples), supervised learning (in which one or more AI/ML models are trained based on input data and corresponding predefined parameters), unsupervised learning (in which one or more AI/ML models are trained without predefined parameters), semi-supervised learning (in which one or more AI/ML models are trained with a mix of predefined data/parameters and non-predefined data/parameter), and reinforcement learning (in which one or more AI/ML models are trained based on input data and a feedback signal resulting from the model's output in an environment the model(s) is interacting with).

According to embodiments, the AI/ML model deployment procedure 460 may include one or more operations for delivering one or more AI/ML models (e.g., trained model, validated model, tested model, etc.) and the associated information (e.g., runtime image, algorithms, etc.) to a target UE or a target network (e.g., target gNB) where one or more inference operations are to be performed. The one or more operations may include a model transfer operation, in which the one or more AI/ML models are delivered over the air interface.

According to embodiments, the AI/ML model roll back procedure 470 may include one or more operations for rolling-back or restoring one or more current AI/ML models to the previous version of AI/ML model(s). For instance, the one or more operations may include replacing or updating the one or more current AI/ML models with the respective previous version of AI/ML models, fine tuning or adjusting the one or more current AI/ML models to its previous version, and the like.

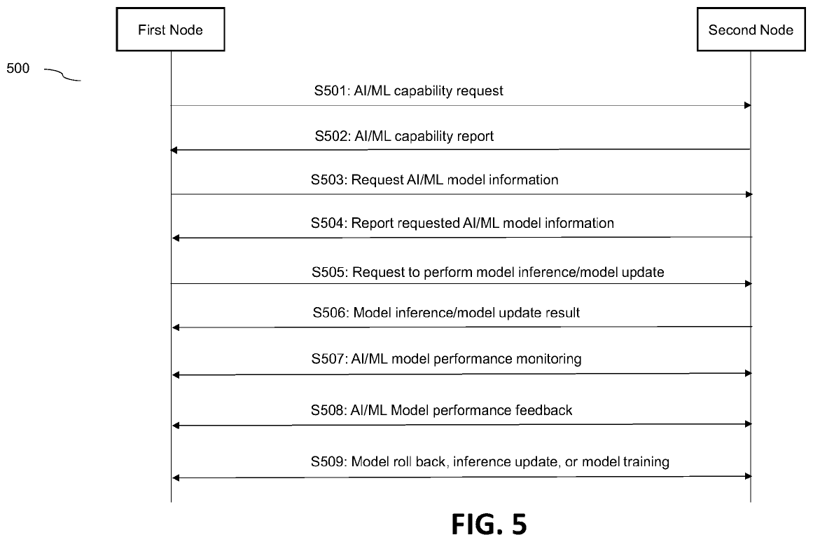

Multiple nodes (e.g., UE, gNB, etc.) may cooperate or collaborate with each other in performing one or more of the above described procedures 410-470. For instance, FIG. 5 illustrates a signaling flow between a first node (e.g., gNB) and a second node (e.g., UE) for a collaborative AI/ML model usage, according to one or more embodiments.

Referring to FIG. 5, the signaling flow may include procedures in FIG. 4, such as AI/ML model capability reporting procedure 410, AI/ML model synchronization 420, AI/ML model update/upgrade procedure 430, AI/ML model performance monitoring procedure 440, AI/ML training/generation procedure 450, and the like.

Specifically, at operation S501, the first node may send, to the second node, one or more AI/ML capability requests. In response, at operations S502, the second node may provide, to the first node, one or more AI/ML capability reports. Operations S501 and S502 may be part of the AI/ML model capability reporting procedure 410 described above with reference to FIG. 4, and the descriptions associated with the one or more AI/ML capability request and the one or more AI/ML capability reports described above with reference to FIG. 2 to FIG. 4 may be applicable herein in a similar manner.

At operation S503, the first node may send, to the second node, one or more requests for AI/ML model(s) and/or the associated information or parameters. In response, at operation S504, the second node may provide, to the first node, one or more reports including the requested AI/ML model(s) and/or the associated information or parameters. Operations S503 and S504 may be part of the AI/ML model synchronization procedure 420 described above with reference to FIG. 4, and the process and features of information exchange and model transfer may be similar to those described above with reference to FIG. 2 to FIG. 4. Thus, it can be understood that similar descriptions may be applicable herein in a similar manner.

At operation S505, the first node may send, to the second node, one or more requests to perform model inference and/or model update. In response, the second node may perform the requested model inference and/or model update, and may provide (at operation S506) to the first node one or more results thereof (e.g., completed, failed, inference value/output, etc.). Operation S505 and S506 may be part of AI/ML model update/upgrade procedure 430, or may be part of AI/ML model deployment procedure 460, described above with reference to FIG. 4. Thus, it can be understood that similar descriptions may be applicable herein in a similar manner.

At operation S507, the first node may monitor the AI/ML model performance at the second node. For instance, the first node may send, to the second node, one or more requests for performance data associated to the AI/ML model(s), and subsequently, at operation S508, the second node may provide one or more feedbacks defining the performance of the AI/ML model(s). According to embodiments in which one or more AI/ML models are also being utilized (e.g., inferenced, updated, etc.) at the first node, the second node may also monitor the AI/ML model performance at the first node in a similar manner. Operations S507 and S508 may be part of AI/ML model performance monitoring procedure 440 described above with reference to FIG. 4. Thus, it can be understood that similar descriptions may be applicable herein in a similar manner.

At operation S509, the first node may determine (e.g., based on the AI/ML performance feedback, etc.) that one or more of model roll back, inference update, and model training is required at the second node. Accordingly, the first node may send, to the second node, one or more requests to perform the model roll back, the inference update, and/or the model training. Operation S509 may include one or more of the AI/ML model update/upgrade procedure 430, the AI/ML model training/generation procedure 450, and the AI/ML model roll back procedure 470, described above with reference to FIG. 4. Thus, it can be understood that similar descriptions may be applicable herein in a similar manner.

To this end, example embodiments of the present disclosure define procedures and signaling flow between the nodes for collaboration and cooperation in utilizing and managing one or more AI/ML models.

### Categorization of AI/ML Model Training

According to embodiments, based on use case requirements and AI/ML capabilities, categories of AI/ML model training may be defined.

For instance, according to one or more embodiments, training of one or more AI/ML models may be performed based on a particular level (or category) of collaboration from among a plurality of predetermined levels (or categories).

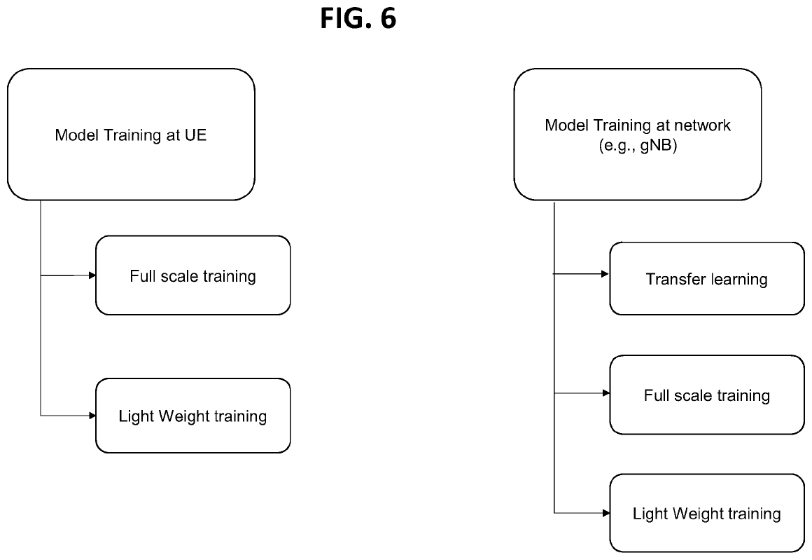

FIG. 6 illustrates a breakdown of categories of AI/ML model trainings, according to one or more embodiments.

Referring to FIG. 6, the AI/ML model trainings may be performed at the UE (e.g., on-UE trainings, etc.) and/or may be performed at the network (e.g., on-network trainings, etc.) such as at the gNB.

Model trainings at the UE may be further categorized into full scale AI/ML model training and light weight AI/ML model training. The full scale AI/ML model training may be a large scale training in which all (or majority) of the data or parameters are utilized for training. Conversely, the light weight AI/ML model training may be a small scale training in which a portion of the data or parameters are utilized for training. The full scale AI/ML model training and/or the light weight AI/ML model training may include one or more of: federated learning/training, supervised learning, unsupervised learning, semi-supervised learning, and reinforcement learning (described above with reference to FIG. 4).

According to embodiments, one or more full scale AI/ML model trainings may be performed at the UE, in accordance with the second level (e.g., second level #1 as described above) collaboration between the UE and a network (e.g., gNB). On the other hand, one or more light weight AI/ML model trainings may be performed at the UE, in accordance with the third level (e.g., third level #2 as described above) collaboration between the UE and the network.

On the other hand, model trainings at the network (e.g., gNB) may be further categorized into transfer AI/ML model training or learning, full scale AI/ML model training, and light weight AI/ML model training. The transfer AI/ML model training may include one or more training operations which utilize knowledge or output obtained from a previous task to improve generalization about the AI/ML model. For instance, the transfer AI/ML model training may include reusing one or more pre-trained models on a new task. The full scale- and light weight-AI/ML model trainings are as described above with reference to the model trainings at the UE.

According to embodiments, the transfer AI/ML model training and/or the light weight AI/ML model training may be performed at the network, whenever the network is required or requested to transfer one or more AI/ML models to the UE. Further, the full scale AI/ML model training may be performed at the network, whenever the network determines that light weight AI/ML model training has been performed at the UE.

To this end, example embodiments of the present disclosures define categories of AI/ML model trainings, according to various conditions and requirements.

### Various Aspects of Embodiments

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

In view of the above, various further respective aspects and features of embodiments of the present disclosure may be defined by the following items:
Item [1]: A method of implementing artificial intelligence/machine learning (AI/ML) for air interface optimization in a mobile telecommunications system, the method including: determining, by a first node, a collaboration level for AI/ML collaboration between a network and a user equipment (UE), from among a plurality of predetermined collaboration levels; performing, by a second node, air interface optimization with respect to the UE using at least one AI/ML model, based on the determined collaboration level, wherein the plurality of predetermined collaboration levels may include: a first level corresponding to AI/ML collaboration between the network and the UE, a second level corresponding to a signaling-based AI/ML collaboration between the network and the UE without model transfer, and a third level corresponding to a signaling-based AI/ML collaboration between the network and the UE with model transfer.
Item [2]: The method according to item [1], wherein in accordance with the second level, AI/ML model training may occur at both the network and the UE.
Item [3]: The method according to any one of items [1]-[2], wherein in accordance with the second level, the network may provide AI/ML model and/or inference tuning parameters to the UE.
Item [4]: The method according to any one of items [1]-[3], wherein: the second level may include a plurality of split levels; a first split level, of the plurality of split levels, may correspond to a signaling-based AI/ML collaboration for one-sided models without joint inference performed jointly across the UE and the network; and a second split level, of the plurality of split levels, may correspond to a signaling-based AI/ML collaboration for two-sided models with/without joint inference performed jointly across the UE and the network.
Item [5]: The method according to any one of items [1]-[3], wherein: the second level may correspond to a signaling-based AI/ML collaboration for one-sided models without joint inference performed jointly across the UE and the network; and the third level may correspond to a signaling-based AI/ML collaboration for two-sided models with/without joint inference performed jointly across the UE and the network.
Item [6]: The method according to any one of items [1]-[5], wherein the model transfer may include at least one of a transfer of parameters of an AI/ML model structure or a transfer of a new AI/ML model with parameters, the new AI/ML model may be a full model or a partial model.
Item [7]: The method according to any one of items [1]-[6], wherein the determining the collaboration level may include: transmitting, by the first node to the UE, an AI/ML capability request inquiring about AI/ML capabilities of the UE; receiving, by the first node from the UE, an AI/ML capability report in response to the AI/ML capability request, the AI/ML capability report indicating the AI/ML capabilities of the UE; and determining the collaboration level, from among the plurality of predetermined collaboration levels, based on the received AI/ML capability report.
Item [8]: The method according to any one of items [1]-[7], wherein the method may further include: transmitting, by the first node to the UE, a request for information on at least one of AI/ML models stored in the UE or AI/ML models to be used by the UE.
Item [9]: The method according to any one of items [1]-[8], wherein the air interface optimization may include at least one of Channel State Information (CSI) feedback enhancement, beam management, and positioning accuracy enhancement.
Item [10]: The method according to any one of items [1]-[9], wherein: in accordance with the second level, full scale AI/ML model training may occur at the UE; and in accordance with the third level, light weight AI/ML model training may occur at the UE.
Item [11]: A system of implementing artificial intelligence/machine learning (AI/ML) for air interface optimization in a mobile telecommunications system, the system including: a first node including a memory storing instructions and at least one processor configured to execute the instructions to: determine a collaboration level for AI/ML collaboration between a network and a user equipment (UE), from among a plurality of predetermined collaboration levels; and a second node including a memory storing instructions and at least one processor configured to execute the instructions to: perform air interface optimization with respect to the UE using at least one AI/ML model, based on the determined collaboration level; wherein the plurality of predetermined collaboration levels may include: a first level corresponding to AI/ML collaboration between the network and the UE, a second level corresponding to a signaling-based AI/ML collaboration between the network and the UE without model transfer, and a third level corresponding to a signaling-based AI/ML collaboration between the network and the UE with model transfer
Item [12]: The system according to item [11], wherein in accordance with the second level, AI/ML model training may occur at both the network and the UE.
Item [13]: The system according to any one of items [11]-[12], wherein in accordance with the second level, the network may provide AI/ML model and/or inference tuning parameters to the UE.
Item [14]: The system according to any one of items [11]-[13], wherein: the second level may include a plurality of split levels; a first split level, of the plurality of split levels, may correspond to a signaling-based AI/ML collaboration for one-sided models without joint inference performed jointly across the UE and the network; and a second split level, of the plurality of split levels, may correspond to a signaling-based AI/ML collaboration for two-sided models with/without joint inference performed jointly across the UE and the network.
Item [15]: The system according to any one of items [11]-[13], wherein: the second level may correspond to a signaling-based AI/ML collaboration for one-sided models without joint inference performed jointly across the UE and the network; and the third level may correspond to a signaling-based AI/ML collaboration for two-sided models with/without joint inference performed jointly across the UE and the network.
Item [16]: The system according to any one of items [11]-[15], wherein the model transfer may include at least one of a transfer of parameters of an AI/ML model structure or a transfer of a new AI/ML model with parameters, the new AI/ML model may be a full model or a partial model.
Item [17]: The method according to any one of items [11]-[16], wherein the at least one processor of the first node may be configured to execute the instructions to determine the collaboration level by: transmitting, by the first node to the UE, an AI/ML capability request inquiring about AI/ML capabilities of the UE; receiving, by the first node from the UE, an AI/ML capability report in response to the AI/ML capability request, the AI/ML capability report indicating the AI/ML capabilities of the UE; and determining the collaboration level, from among the plurality of predetermined collaboration levels, based on the received AI/ML capability report.
Item [18]: The system according to any one of items [11]-[17], wherein the at least one processor of the first node may be further configured to execute the instructions to transmit, to the UE, a request for information on at least one of AI/ML models stored in the UE or AI/ML models to be used by the UE
Item [19]: The system according to any one of items [11]-[18], wherein the air interface optimization may include at least one of Channel State Information (CSI) feedback enhancement, beam management, and positioning accuracy enhancement.
Item [20]: The system according to any one of items [11]-[19], wherein: in accordance with the second level, full scale AI/ML model training may occur at the UE; and in accordance with the third level, light weight AI/ML model training may occur at the UE.
Item [21]: The method according to any one of items [1]-[10], wherein in accordance with the second level, the network may provide AI/ML model and/or inference tuning parameters to the UE based on an identity (ID) of the AI/ML model.
Item [22]: The system according to any one of items [11]-[20], wherein in accordance with the second level, the network may provide AI/ML model and/or inference tuning parameters to the UE based on an identity (ID) of the AI/ML model.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A method of implementing artificial intelligence/machine learning (AI/ML) for air interface optimization in a mobile telecommunications system, the method comprising:
determining, by a first node, a collaboration level for AI/ML collaboration between a network and a user equipment (UE), from among a plurality of predetermined collaboration levels;
performing, by a second node, air interface optimization with respect to the UE using at least one AI/ML model, based on the determined collaboration level,
wherein the plurality of predetermined collaboration levels comprises:
a first level corresponding to AI/ML collaboration between the network and the UE,
a second level corresponding to a signaling-based AI/ML collaboration between the network and the UE without model transfer, and
a third level corresponding to a signaling-based AI/ML collaboration between the network and the UE with model transfer.

2. The method as claimed in claim 1, wherein in accordance with the second level, AI/ML model training occurs at both the network and the UE.

3. The method as claimed in claim 1, wherein in accordance with the second level, the network provides AI/ML model and/or inference tuning parameters to the UE.

4. The method as claimed in claim 1, wherein:
the second level comprises a plurality of split levels;
a first split level, of the plurality of split levels, corresponds to a signaling-based AI/ML collaboration for one-sided models without joint inference performed jointly across the UE and the network; and
a second split level, of the plurality of split levels, corresponds to a signaling-based AI/ML collaboration for two-sided models with joint inference performed jointly across the UE and the network.

5. The method as claimed in claim 1, wherein:
the second level corresponds to a signaling-based AI/ML collaboration for one-sided models without joint inference performed jointly across the UE and the network; and
the third level corresponds to a signaling-based AI/ML collaboration for two-sided models with joint inference performed jointly across the UE and the network.

6. The method as claimed in claim 1, wherein the model transfer comprises at least one of a transfer of parameters of an AI/ML model structure or a transfer of a new AI/ML model with parameters, the new AI/ML model being a full model or a partial model.

7. The method as claimed in claim 1, wherein the determining the collaboration level comprises:
transmitting, by the first node to the UE, an AI/ML capability request inquiring about AI/ML capabilities of the UE;
receiving, by the first node from the UE, an AI/ML capability report in response to the AI/ML capability request, the AI/ML capability report indicating the AI/ML capabilities of the UE; and
determining the collaboration level, from among the plurality of predetermined collaboration levels, based on the received AI/ML capability report.

8. The method as claimed in claim 1, further comprising:
transmitting, by the first node to the UE, a request for information on at least one of AI/ML models stored in the UE or AI/ML models to be used by the UE.

9. The method as claimed in claim 1, wherein the air interface optimization comprises at least one of Channel State Information (CSI) feedback enhancement, beam management, and positioning accuracy enhancement.

10. The method as claimed in claim 1, wherein:
in accordance with the second level, full scale AI/ML model training occurs at the UE; and
in accordance with the third level, light weight AI/ML model training occurs at the UE.

11. A system of implementing artificial intelligence/machine learning (AI/ML) for air interface optimization in a mobile telecommunications system, the system comprising:
a first node comprising a memory storing instructions and at least one processor configured to execute the instructions to: determine a collaboration level for AI/ML collaboration between a network and a user equipment (UE), from among a plurality of predetermined collaboration levels; and
a second node comprising a memory storing instructions and at least one processor configured to execute the instructions to: perform air interface optimization with respect to the UE using at least one AI/ML model, based on the determined collaboration level;
wherein the plurality of predetermined collaboration levels comprises:
a first level corresponding to AI/ML collaboration between the network and the UE,
a second level corresponding to a signaling-based AI/ML collaboration between the network and the UE without model transfer, and
a third level corresponding to a signaling-based AI/ML collaboration between the network and the UE with model transfer.

12. The system as claimed in claim 11, wherein in accordance with the second level, AI/ML model training occurs at both the network and the UE.

13. The system as claimed in claim 11, wherein in accordance with the second level, the network provides AI/ML model and/or inference tuning parameters to the UE.

14. The system as claimed in claim 11, wherein:
the second level comprises a plurality of split levels;
a first split level, of the plurality of split levels, corresponds to a signaling-based AI/ML collaboration for one-sided models without joint inference performed jointly across the UE and the network; and
a second split level, of the plurality of split levels, corresponds to a signaling-based AI/ML collaboration for two-sided models with joint inference performed jointly across the UE and the network.

15. The system as claimed in claim 11, wherein:
the second level corresponds to a signaling-based AI/ML collaboration for one-sided models without joint inference performed jointly across the UE and the network; and
the third level corresponds to a signaling-based AI/ML collaboration for two-sided models with joint inference performed jointly across the UE and the network.

16. The system as claimed in claim 11, wherein the model transfer comprises at least one of a transfer of parameters of an AI/ML model structure or a transfer of a new AI/ML model with parameters, the new AI/ML model being a full model or a partial model.

17. The system as claimed in claim 11, wherein the at least one processor of the first node is configured to execute the instructions to determine the collaboration level by:
transmitting, by the first node to the UE, an AI/ML capability request inquiring about AI/ML capabilities of the UE;
receiving, by the first node from the UE, an AI/ML capability report in response to the AI/ML capability request, the AI/ML capability report indicating the AI/ML capabilities of the UE; and
determining the collaboration level, from among the plurality of predetermined collaboration levels, based on the received AI/ML capability report.

18. The system as claimed in claim 11, wherein the at least one processor of the first node is further configured to execute the instructions to transmit, to the UE, a request for information on at least one of AI/ML models stored in the UE or AI/ML models to be used by the UE.

19. The system as claimed in claim 11, wherein the air interface optimization comprises at least one of Channel State Information (CSI) feedback enhancement, beam management, and positioning accuracy enhancement.

20. The system as claimed in claim 11, wherein:
in accordance with the second level, full scale AI/ML model training occurs at the UE; and
in accordance with the third level, light weight AI/ML model training occurs at the UE.
